(19) United States
(12) Patent Application Publication
(10) Pub. No.: US 2007/0086650 A1
(43) Pub. Date: Apr. 19, 2007

(54) Method and Device for Color Saturation and Sharpness Enhancement

(76) Inventors: KEH-TSONG LI, Taipei (TW); Keh-Yang Lee, Taipei (TW); Tzu-Yang Huang, Taipei (TW)

Correspondence Address: Bayshore Patent Group, LLC, 520 Chantecler Dr., Fremont, CA, 94539, US

(21) Appl. No.: 11/538,830

(22) Filed: Oct. 5, 2006

Related U.S. Application Data
(60) Provisional application No. 60/723,773, filed on Oct. 6, 2005.

(51) Int. Cl. G06K 9/00

(52) U.S. Cl. 382/162

(57) ABSTRACT

The present invention comprises of a digital image processing method which simultaneously enhances color saturation and sharpness on a pixel-by-pixel basis directly in RGB color space, the most popular color space used to represent digital color images, and does not cause color hue shifts. The method comprises the steps of: developing a surround function to analyze the local brightness uniformity in a digital image; generating an intermediate image using the brightness uniformity; calculating enhancement values with a gain function in each of the RGB channels for each pixel; and adding the enhancement values to the respective RGB channels for each pixel to produce an adjusted digital color image with enhanced color saturation and sharpness.

### TECHNICAL FIELD OF THE INVENTION

The present invention relates to methods of processing digital color images, and more particularly to methods of adjusting the color saturation and sharpness of a digital color image.

### BACKGROUND OF THE INVENTION

To cope with poor color quality of digital images, color saturation adjustment is necessary. RGB color space is the most common space used to represent image data but color saturation adjustment is not an easy task to perform in RGB color space. Traditional color saturation adjustment methods transform the original image data from RGB color space to HIS color space or YCrCb color space, multiply the saturation by a constant α, and then transform the processed image from HIS or YCrCb color space back to RGB color space.

However, there exist two shortcomings in this kind of processing. First, color space transformation is a necessary step in such saturation adjustments, and requires additional computing power. Second, these traditional methods multiply the saturation by a constant α for the whole image, and do not consider regional differences.

For improvement, some investigators have spent efforts to improve these two problems. To solve the first problem, Kim [1] proposes a method for adjusting the saturation of a digit image in an RGB color space. This method can directly adjust the saturation by decomposing an RGB color sample vector C̅ into a white vector w̅ and a color tone vector C̅_{T}. Additionally, Johannesson and Larsson [2] propose a special matrix to adjust the saturation of a digital image. By using the said matrix, their method can adjust the saturation value without the conversion process from RGB color space to HIS color space or YCrCb color space. To solve the second problem, Kim [3] uses a histogram method to calculate the peak and mean values of the saturation in a digital image and then adjusts the saturation value by the peak and mean values. However, none of the above techniques that adjust color saturation directly in RGB color space have proven entirely satisfactory in addressing the problem of enhancing color saturation and sharpness of digital color images without causing color hue shifts. Therefore, there is a need for an improved, computationally efficient digital image processing method for enhancing color saturation and sharpness of a digital image.

### SUMMARY OF THE INVENTION

The need is met according to the present invention by providing a digital image processing method of enhancing color saturation and sharpness directly in RGB color space, the most popular color space used to represent digital color images. The method comprises the steps of: developing a surround function to analyze the local brightness uniformity in a digital image on a pixel-by-pixel basis; generating an intermediate image using the brightness uniformity; calculating enhancement values in each of RGB channels with a gain function on a pixel-by-pixel basis; and adding the enhancement values to the respective RGB channels for each pixel to produce an adjusted digital color image with enhanced color saturation and sharpness.

The present invention has the advantages that it is performed directly in RGB color space, that it does not require extra steps of performing computationally inefficient color space transformation, that it does not cause color hue shifts, that it is computationally efficient, and that it is performed on a pixel-by-pixel basis.

### BRIEF DESCRIPTION OF THE DRAWINGS

FIG. 1 shows a block diagram illustrating image processing methods for adjusting color saturation using HIS color space transformation.

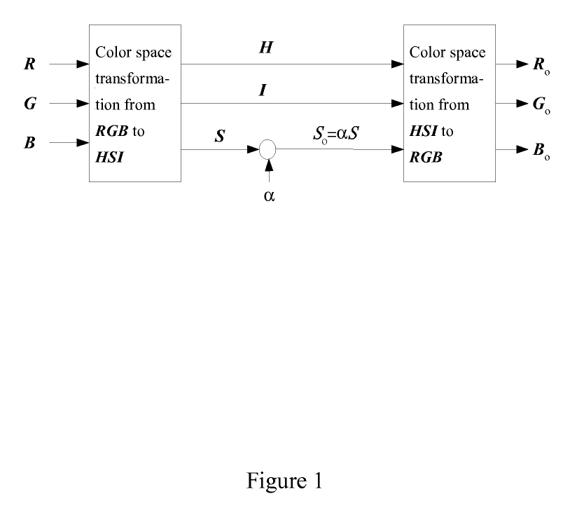

FIG. 2 shows a block diagram illustrating image processing methods for adjusting color saturation using YCrCb color space transformation.

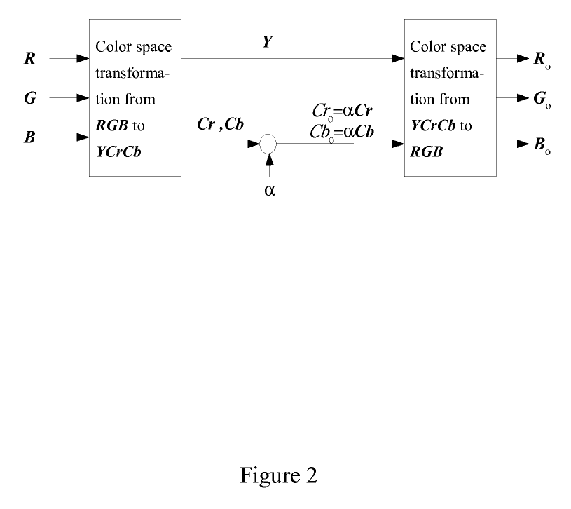

FIG. 3 shows a schematic block diagram illustrating an image processing system suitable for performing the image processing method of the present invention.

FIG. 4 shows a flow chart explaining the adaptive image processing method of the present invention.

FIG. 5A shows a test image for sharpness adjustment.

FIG. 5B shows an image after being processed by the present invention.

FIG. 6A shows a test image for color saturation adjustment.

FIG. 6B shows an image after being processed by the present invention.

### DESCRIPTION OF THE NUMBERING

10 Original image
20 Processing method
201,203,205 Steps

For persons of ordinary skill in the art to understand the purpose, features and effects of the present invention, the invention is described in details as follows, along with examples and figures.

### DESCRIPTION OF THE INVENTION

In order to circumvent the shortcomings of conventional color saturation adjustments that require color space transformation, create color hue shifts and do not perform on a pixel-by-pixel basis, the present invention proposes an image processing method for digital images. It imitates the adaptiveness of human eyes to improve the color adjustment and sharpness of digital images by adjusting to various surrounding conditions. With the concept of adaptiveness, the present invention is able to perform color saturation adjustment and sharpness enhancement of images without the need of color space transformation.

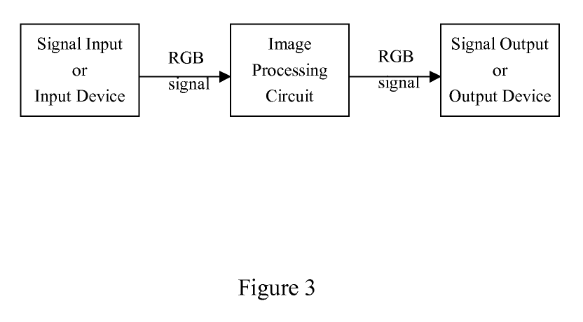

FIG. 3 shows a schematic block diagram illustrating an image processing system suitable for performing the image processing method of the present invention. The image processing circuit can be an ASIC (application specific integrated circuit), which implements the proposed algorithm. Or the image processing circuit can be a general-purposed processor such as a DSP or CPU that process the proposed algorithm.

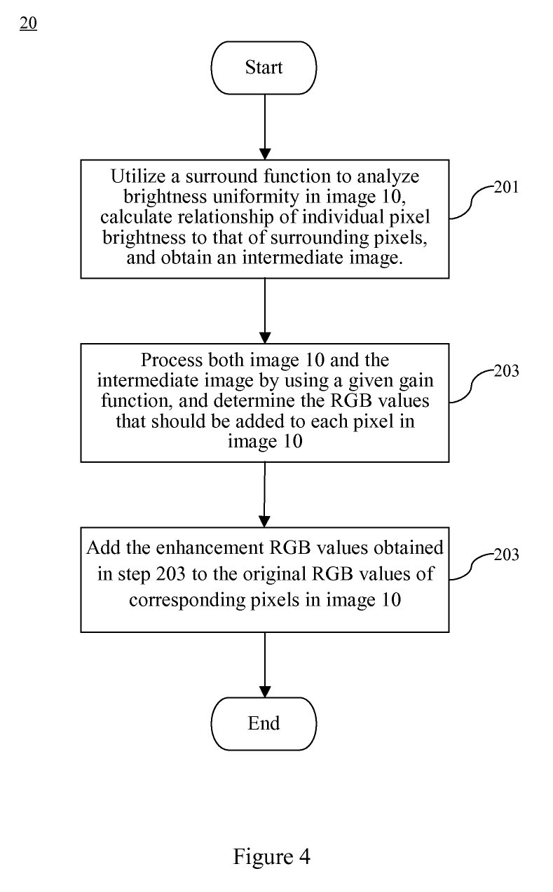

FIG. 4 shows a flow chart explaining the steps of the present invention. Method 20 proposed in the present invention comprises of step 201, step 203 and step 205, which are described as follows. Step 201 utilizes a surround function to analyze brightness uniformity of image 10, calculate relationship of individual pixel brightness to that of surrounding pixels, and obtain an intermediate image. This brightness relationship is an important piece of information obtained in step 201. Step 203 applies the brightness uniformity to set a gain function to decide the required adjustments on the R, G and B values of each pixel in image 10. Step 205 generates an image with better color saturation and sharpness in which the value of each pixel is the sum of the adjusted R, G and B values. As described above, the present invention is capable of enhancing image 10 via steps 201, 203 and 205.

Analogous to the adaptiveness in human vision, the adjustment of color saturation can relate to the brightness of surrounding environments. To adjust color saturation and enhance sharpness simultaneously, a pixel, which is brighter than its surrounding pixels, should receive higher color saturation while a pixel, which has the same brightness and is less brighter than its surrounding pixels, should receive lower color saturation. After the color saturation is adjusted for all pixels according to the brightness of their surrounding pixels, the sharpness is therefore enhanced because of the better distribution of color saturation in the whole image. In step 201, an image can be described as

$$\begin{matrix}D ( x , y ) = I ( x , y ) * F ( x , y ) \\ = {\sum }_{m = - ∞}^{∞} {\sum }_{n = - ∞}^{∞} I ( m , n ) F ( x - m , y - n ) \\ I ( x , y ) = \frac{1}{3} ( R ( x , y ) + G ( x , y ) + B ( x , y ) )\end{matrix} \qquad Eq . 1$$

where * represents convolution, D(x,y) is an intermediate image, I(x,y) represents brightness values in image 10, R(x,y), G(x,y) and B(x,y) are R, G and B values in image 10, and F(x,y) is the surround function used to calculate the brightness relationship. A one-dimensional or two-dimensional low-pass filter is chosen as F(x,y) to calculate brightness relationship of individual pixel brightness to that of surrounding pixels, followed by step 203 involving the gain function. In step 203, the adjustment values in R, G and B channels of each pixel are based on
C_{Gain}×(R(x,y)−D(x,y))
C_{Gain}×(G(x,y)−D(x,y))
C_{Gain}×(B(x,y)−D(x,y)) Eq. 2
where D(x,y) is the intermediate image obtained in Eq. 1 and C_{Gain} is a gain coefficient whose main function is to control the level of adjustment of color saturation.

In step 205, the adjustment values in R, G, and B channels obtained in Eq. 2 are added to the original R, G and B values, forming a final adjusted image. In summary, method 20 can be written as
R̅(x,y)=R(x,y)+C_{Gain}×(R(x,y)−D(x,y))
G̅(x,y)=G(x,y)+C_{Gain}×(G(x,y)−D(x,y))
B̅(x,y)=B(x,y)+C_{Gain}×(B(x,y)−D(x,y)) Eq. 2
where R̅(x,y), G̅(x,y), B̅(x,y) are the final values of each pixel.

The main feature of the present invention is the capability of performing pixel-by-pixel, computationally efficient color saturation adjustment and sharpness enhancement directly via RGB channels while maintaining the color hue in the original picture. The following will describe further the advantages of using Eq. 3 as a processing method.

In general, when adjusting color saturation, hue must remain unchanged to avoid hue shifts. RGB color space is the most popular method to describe digital color images; however, most of image processing methods operating directly on RGB channels cause hue shift problem. Therefore, HSI color space is often chosen for color manipulation. The relationship between RGB color space and HSI color space is

$$\begin{matrix}I = \frac{1}{3} ( R + G + B ) & Eq . 4 \\ S = 1 - \frac{3}{( R + G + B )} [ min ( R , G , B ) ] & Eq . 5 \\ H = {cos}^{- 1} \{ \frac{[ ( R - G ) + ( R - B ) ] / 2}{{[ {( R - G )}^{2} + ( R - B ) ( G - B ) ]}^{1 \text{/} 2}} \} & Eq . 6\end{matrix}$$

where I is intensity, S is saturation and H is hue. To explain the advantage of using Eq. 3, we first substitute Eq. 3 into Eq. 4:

$$\begin{matrix}\overline{I} ( x , y ) = \frac{1}{3} ( \overline{R} ( x , y ) + \overline{G} ( x , y ) + \overline{B} ( x , y ) ) \\ = \frac{1}{3} ( R ( x , y ) + G ( x , y ) + B ( x , y ) ) + \\ \frac{1}{3} {C}_{Gain} \times ( R ( x , y ) + G ( x , y ) + B ( x , y ) - 3 D ( x , y ) )\end{matrix} \qquad Eq . 7$$

where I̅(x,y) is the adjusted intensity, D(x,y) is the intermediate image obtained by using the suround function in step 201 and C_{Gain} is a gain coefficient. Since D(x,y) is calculated by applying a low-pass filter on the original intensity I(x,y), D(x,y) will be equal to I(x,y) when I(x,y) is equal to the intensity value of surrounding pixels. In such cases, Eq. 7 leads to

$$\begin{matrix}\overline{I} ( x , y ) = \frac{1}{3} ( R ( x , y ) + G ( x , y ) + B ( x , y ) ) + \\ \frac{1}{3} {C}_{Gain} \times ( R ( x , y ) + G ( x , y ) + B ( x , y ) - 3 I ( x , y ) ) \\ = \frac{1}{3} ( R ( x , y ) + G ( x , y ) + B ( x , y ) ) + \frac{1}{3} {C}_{Gain} \times \\ ( R ( x , y ) + G ( x , y ) + B ( x , y ) - 3 \\ ( \frac{1}{3} ( R ( x , y ) + G ( x , y ) + B ( x , y ) ) ) ) \\ = \frac{1}{3} ( R ( x , y ) + G ( x , y ) + B ( x , y ) ) = I ( x , y )\end{matrix} \qquad Eq . 8$$

According to the above explanation, intensity will not be changed by using Eq. 3 when I(x,y) is equal to the intensity value of surrounding pixels. When I(x,y) is larger then the intensity value of surrounding pixels, it will lead to
[R(x,y)+G(x,y)+B(x,y)]>3D(x,y) Eq. 9
and I̅(x,y) will be larger than I(x,y), i.e. the intensity is magnified with respect to surrounding pixels. When I(x,y) is smaller then the intensity value of surrounding pixels, I̅(x,y) will be smaller than I(x,y). Therefore, using Eq. 3 can enhance the sharpness of a picture by adaptively adjusting the intensity of each pixel.

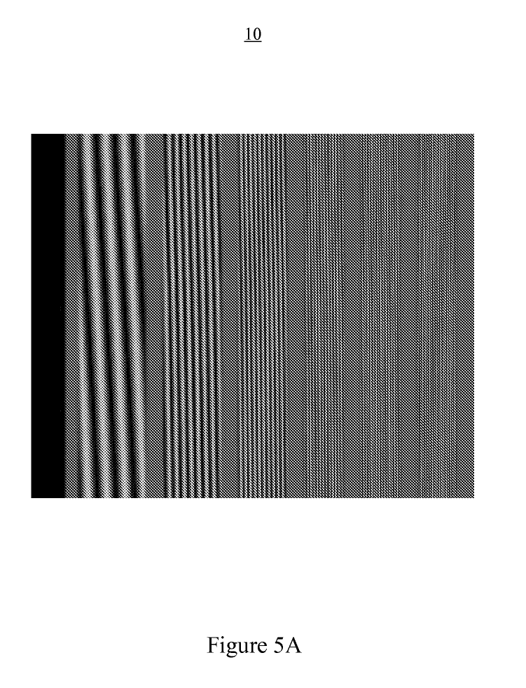

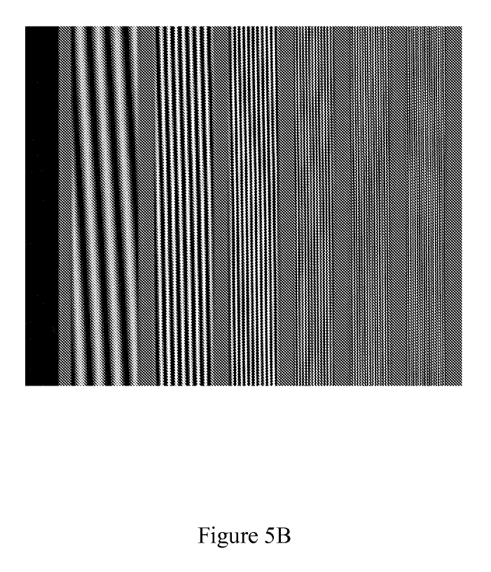

FIGS. 5A and 5B demonstrate the sharpness enhancement results of using the image processing described in Eq. 3 on original image 10. FIG. 5A is an image (original image 10) for testing sharpness enhancement. FIG. 5B is a sharpness-enhanced image by using the present method described in Eq. 3, which show an outstanding sharpness enhancement result.

Next, we would like to explain the effect of the present invention described in Eq. 3 on saturation. Substituting Eq. 3 into Eq. 5 leads to

$$\begin{matrix}\overline{S} ( x , y ) = 1 - \frac{3 [ min ( \overline{R} ( x , y ) , \overline{G} ( x , y ) , \overline{B} ( x , y ) ) ]}{( \overline{R} ( x , y ) + \overline{G} ( x , y ) + \overline{B} ( x , y ) )} \\ = 1 - \frac{[ min ( \overline{R} ( x , y ) , \overline{G} ( x , y ) , \overline{B} ( x , y ) ) ]}{\overline{I} ( x , y )} \\ where \\ \overline{R} ( x , y ) = R ( x , y ) + {C}_{Gain} \times ( R ( x , y ) - D ( x , y ) ) \\ \overline{G} ( x , y ) = G ( x , y ) + {C}_{Gain} \times ( G ( x , y ) - D ( x , y ) ) \\ \overline{B} ( x , y ) = B ( x , y ) + {C}_{Gain} \times ( B ( x , y ) - D ( x , y ) )\end{matrix} \qquad Eq . 10$$

and S̅(x,y) is the adjusted saturation. When I(x,y) is equal to the intensity value of surrounding pixels, comparing Eq. 8 and Eq. 10 leads to
[min( R̅(x,y), G̅(x,y), B̅(x,y))]<[min(R(x,y),G(x,y),B(x,y))]
i.e. the adjusted saturation S̅(x,y) must be greater than the original saturation S(x,y). When I(x,y) is larger then the intensity value of surrounding pixels, I(x,y) will be adjusted to be larger than I(x,y) and, hence, S̅(x,y) will be enhanced to be larger than S(x,y). When I(x,y) is smaller then the intensity value of surrounding pixels, I̅(x,y) will be adjusted to be smaller than I(x,y) and, hence, S̅(x,y) will be adaptively changed to be smaller than S(x,y). Therefore, no matter I(x,y) is larger than, equal to or smaller than the intensity value of surrounding pixels, the present invention described in Eq. 3 can always adaptively enhance the saturation and increase color depth in a digital image and is different from other image processing methods that apply one gain on all pixels of an image. Moreover, the present invention directly operates in RGB color space and does not require color space transformation.

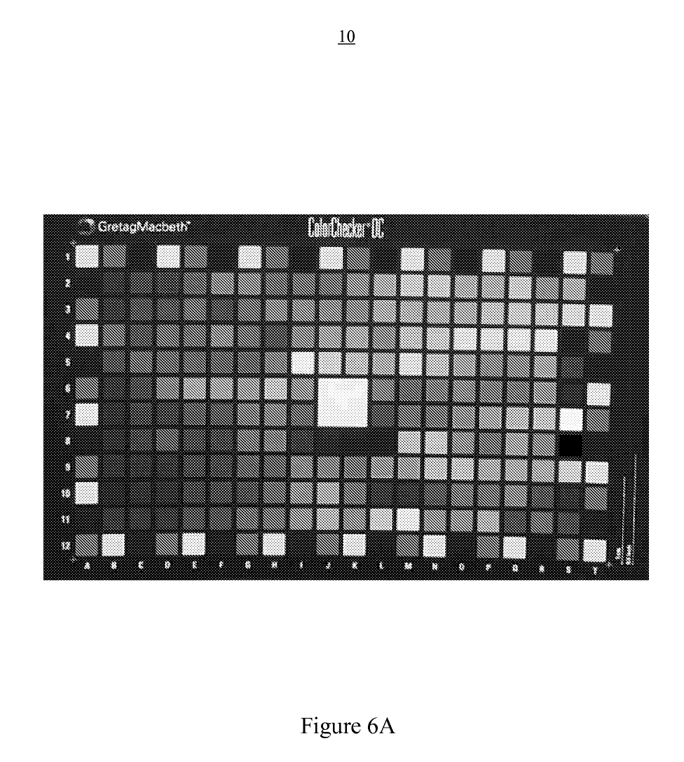

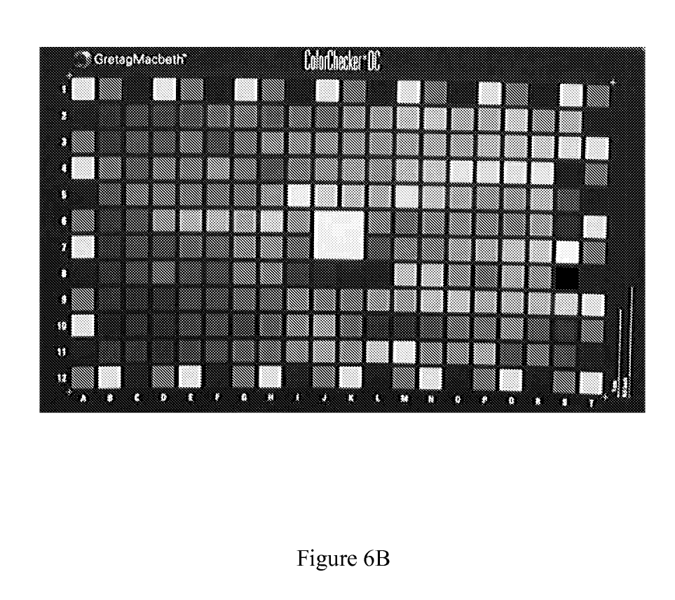

FIGS. 6A and 6B demonstrate the saturation enhancement results of using the image processing described in Eq. 3 on original image 10. FIG. 6A is a test image (original image 10). FIG. 6B is a saturation-enhanced image by using the present method described in Eq. 3, which show an outstanding sharpness enhancement result.

At last, we would like to explain the effect of the present invention on hue. Substituting Eq. 3 into Eq. 6 gets

$$\begin{matrix}\overline{H} ( x , y ) = {cos}^{- 1} \{ \frac{\frac{0.5 \times [ ( \overline{R} ( x , y ) - \overline{G} ( x , y ) ) +}{( \overline{R} ( x , y ) - \overline{B} ( x , y ) ) ]}}{\frac{[ {( \overline{R} ( x , y ) - \overline{G} ( x , y ) )}^{2} + ( \overline{R} ( x , y ) -}{{\overline{B} ( x , y ) ) ( \overline{G} ( x , y ) - \overline{B} ( x , y ) ) ]}^{1 \text{/} 2}} } \} \\ = {cos}^{- 1} \{ \frac{\frac{0.5 \times [ ( R ( x , y ) - G ( x , y ) ) +}{( R ( x , y ) - B ( x , y ) ) ] ( 1 + {C}_{Gain} )}}{\frac{[ {( R ( x , y ) - G ( x , y ) )}^{2} + ( R ( x , y ) -}{{B ( x , y ) ) ( G ( x , y ) - B ( x , y ) ) ]}^{1 \text{/} 2}}} \} \\ = {cos}^{- 1} \{ \frac{\frac{0.5 \times [ ( R ( x , y ) - G ( x , y ) ) +}{( R ( x , y ) - B ( x , y ) ) ]}}{\frac{[ {( R ( x , y ) - G ( x , y ) )}^{2} + ( R ( x , y ) -}{{B ( x , y ) ) ( G ( x , y ) - B ( x , y ) ) ]}^{1 \text{/} 2}}} \} \\ = H ( x , y )\end{matrix}$$

where H̅(x,y) is the adjusted hue and H(x,y) is the original hue. It is shown that the value of hue remains constant by using the present method described in Eq. 3.

In summary, the present invention described in Eq. 3 can enhance the sharpness and saturation of images in a pixel-by-pixel fashion, increase color depth and gradation, keep the hue of images unchanged and operate in RGB color space without the need of color space transformation.

Moreover, method 20 in the present invention can be realized in an electronic device, which can further be integrated into a digital camera, a monitor, a television or any other image output device.

It should be noted that the functionality of the present invention is exemplified, but not limited to, the instance provided in this patent document. Definitions for certain words and phrases are provided throughout this patent document, and those of ordinary skill in the art should understand that in many, if not most instances, such definitions apply to prior, as well as future uses of such defined words and phrases.

What is claimed is:

1. A method for simultaneously adjusting color saturation and sharpness, said
method comprising:
(a) a step that is capable of utilizing a surround function to analyze local brightness uniformity of an image;
(b) a step that is capable of applying the obtained brightness uniformity to set a gain function to decide the required adjustments on the values of RGB (red, green and blue) color channels of each pixel;
(c) a step that is capable of generating an enhanced image in which the final value of a pixel is the sum of the adjusted values of R, G and B channels.

2. The method set forth in claim 1 wherein said step (a) is capable of using an equation
$$\begin{matrix}D ( x , y ) = I ( x , y ) * F ( x , y ) \\ = {\sum }_{m = - ∞}^{∞} {\sum }_{n = - ∞}^{∞} I ( m , n ) F ( x - m , y - n ) \\ I ( x , y ) = \frac{1}{3} ( R ( x , y ) + G ( x , y ) + B ( x , y ) )\end{matrix}$$
to obtain an intermediate image, * is convolution operation, I(x,y) is the brightness value, F(x,y) is a surround function, and D(x,y) is an intermediate image.

3. The method set forth in claim 2 wherein said F(x,y) can be an one-dimensional or two-dimensional low-pass filter.

4. The method set forth in claim 2 wherein said F(x,y) can be an one-dimensional or two-dimensional vector function.

5. The method set forth in claim 1 wherein said step (b) is capable of using
C_{Gain}×(R(x,y)−D(x,y))
C_{Gain}×(G(x,y)−D(x,y))
C_{Gain}×(B(x,y)−D(x,y))
to decide the required enhancements on each pixel of the original image, I(x,y) is the original image, D(x,y) is the intermediate image, and C_{Gain} is an gain coefficient, R(x,y) is the value of red color channel of the original image, G(x,y) is the value of green color channel of the original image, B(x,y) is the value of blue color channel of the original image.

6. The method set forth in claim 5 wherein said gain coefficient is a constant.

7. The method set forth in claim 1 wherein said step (a), said step (b) and said step (c) use
$$\begin{matrix}R ( x , y ) + {C}_{Gain} \times ( R ( x , y ) - D ( x , y ) ) \\ G ( x , y ) + {C}_{Gain} \times ( G ( x , y ) - D ( x , y ) ) \\ B ( x , y ) + {C}_{Gain} \times ( B ( x , y ) - D ( x , y ) ) \\ D ( x , y ) = I ( x , y ) * F ( x , y ) \\ I ( x , y ) = \frac{1}{3} ( R ( x , y ) + G ( x , y ) + B ( x , y ) )\end{matrix}$$
to process a color digital image, I(x,y) is the original image, D(x,y) is the intermediate image, C_{Gain} is an gain coefficient, R(x,y) is the value of red color channel of the original image, G(x,y) is the value of green color channel of the original image, B(x,y) is the value of blue color channel of the original image.

8. The method set forth in claim 1 wherein said step (b) is capable of using
C_{Gain}×(R(x,y)−I(x,y))
C_{Gain}×(G(x,y)−I(x,y))
C_{Gain}×(B(x,y)−I(x,y))
to decide the required enhancements on each pixel of the original image when adjusting color saturation but sharpness, I(x,y) is the original image, C_{Gain} is an gain coefficient, R(x,y) is the value of red color channel of the original image, G(x,y) is the value of green color channel of the original image, B(x,y) is the value of blue color channel of the original image.

9. An electronic device of implementing the method set forth in claim 1.

10. The device set forth in claim 9 wherein said electronic device is a digital camera.

11. The device set forth in claim 9 wherein said electronic device is a monitor.

12. The device set forth in claim 9 wherein said electronic device is a television.

13. The device set forth in claim 9 wherein said electronic device is a printer.

14. The device set forth in claim 9 wherein said electronic device is an image output device.
